(19) United States
(12) Patent Application Publication
(10) Pub. No.: US 2022/0300818 A1
(43) Pub. Date: Sep. 22, 2022

(54) STRUCTURE OPTIMIZATION APPARATUS, STRUCTURE OPTIMIZATION METHOD, AND COMPUTER-READABLE RECORDING MEDIUM

(71) Applicant: NEC Solution Innovtors, Ltd., Koto-ku, Tokyo (JP)

(72) Inventor: Noboru NAKAJIMA, Tokyo (JP)

(73) Assignee: NEC Solution Innovators, Ltd., Koto-ku, Tokyo (JP)

(21) Appl. No.: 17/780,100

(22) PCT Filed: Dec. 3, 2020
(86) PCT No.: PCT/JP2020/044994

§ 371 Date: May 26, 2022

(30) Foreign Application Priority Data
Dec. 3, 2019 (JP) 2019-218605

(51) Int. Cl. G06N 3/08

(52) U.S. Cl. CPC G06N 3/082

(57) ABSTRACT

A structure optimization apparatus 1 for optimizing a structured network and reducing a calculation amount of a computing unit includes a generation unit 2 configured to generate a residual network that shortcuts one or more intermediate layers in a structured network, a selection unit 3 configured to select an intermediate layer according to a first degree of contribution of the intermediate layer to processing executed using the structured network, and a deletion unit 4 configured to delete the selected intermediate layer.

### TECHNICAL FIELD

The present invention relates to a structure optimization apparatus and a structure optimization method for optimizing a structured network and further relates to a computer-readable recording medium that includes a program recorded thereon for realizing the apparatus and method.

### BACKGROUND ART

In a structured network that is used in machine learning such as deep learning and a neural network, when the number of intermediate layers that constitute the structured network increases, the calculation amount of a computing unit also increases. For this reason, it takes a long time for a computing unit to output a result of processing such as identification and classification. Examples of a computing unit include a CPU (Central Processing Unit), a GPU (Graphical Processing Unit), and an FPGA (Field-Programmable Gate Array).

In view of this, a structured network pruning algorithm for pruning neurons (e.g., artificial neurons such as perceptrons, sigmoid neurons, and nodes) included in the intermediate layers, and the like is known as a technique for reducing the calculation amount of a computing unit. A neuron is a unit for executing multiplication and addition using input values and weights.

As a related technique, Non-Patent Document 1 discloses considerations regarding structured network pruning algorithms. The structured network pruning algorithm is a technique for reducing the calculation amount of a computer by detecting idling neurons and pruning the detected idling neurons. Idling neurons are neurons whose degree of contribution to processing such as identification and classification is low.

### LIST OF RELATED ART DOCUMENTS

### Non-Patent Document

Non-Patent Document 1: Zhuang Liu, Mingjie Sun2, Tinghui Zhou, Gao Huang, Trevor Darrell, “RETHINKING THE VALUE OF NETWORK PRUNING”, 28 Sep. 2018 (modified: 6 Mar. 2019), ICLR 2019 Conference

### SUMMARY OF INVENTION

### Technical Problems

Meanwhile, the structured network pruning algorithm described above is an algorithm for pruning the neurons in intermediate layers, but it is not an algorithm for pruning the intermediate layers. That is, the structured network pruning algorithm is not an algorithm for reducing the intermediate layers whose degree of contribution to processing such as identification and classification is low in the structured network.

Further, since the structured network pruning algorithm described above prunes neurons, the accuracy of processing such as identification and classification may decrease.

An example object of the invention is to provide a structure optimization apparatus, a structure optimization method, and a computer-readable recording medium, with which a structured network can be optimized and the calculation amount of a computing unit can be reduced.

### Solution to the Problems

In order to achieve the aforementioned object, a structure optimization apparatus according to an example aspect of the invention includes:

a generation unit configured to generate a residual network that shortcuts one or more intermediate layers in a structured network;

a selection unit configured to select an intermediate layer according to a first degree of contribution of the intermediate layer to processing executed using the structured network; and

a deletion unit configured to delete the selected intermediate layer.

Also, in order to achieve the aforementioned object, a structure optimization method according to an example aspect of the invention includes:

a generating step for generating a residual network that shortcuts one or more intermediate layer in a structured network;

a selecting step for selecting an intermediate layer according to a first degree of contribution of the intermediate layer to processing executed using the structured network; and

a deleting step for deleting the selected intermediate layer.

Furthermore, in order to achieve the aforementioned object, a computer readable recording medium according to an example aspect of the invention includes a program recorded thereon, the program including instructions that cause a computer to carry out:

a generating step for generating a residual network that shortcuts one or more intermediate layer in a structured network;

a selecting step for selecting an intermediate layer according to a first degree of contribution of the intermediate layer to processing executed using the structured network; and

a deleting step for deleting the selected intermediate layer.

### Advantageous Effects of the Invention

According to the invention as described above, a structured network can be optimized and the calculation amount of a computing unit can be reduced.

### BRIEF DESCRIPTION OF THE DRAWINGS

FIG. 1 is a diagram showing an example of a structure optimization apparatus.

FIG. 2 is a diagram showing an example of a learning model.

FIG. 3 is a diagram for illustrating a residual network.

FIG. 4 is a diagram showing an example of a system including the structure optimization apparatus.

FIG. 5 is a diagram showing an example of a residual network.

FIG. 6 is a diagram showing an example of a residual network.

FIG. 7 is a diagram showing an example in which an intermediate layer is deleted from a structured network.

FIG. 8 is a diagram showing an example in which the intermediate layer has been deleted from a structured network.

FIG. 9 is a diagram showing an example of a connection between neurons and connections.

FIG. 10 is a diagram showing an example of operations of a system including the structure optimization apparatus.

FIG. 11 is a diagram showing an example of operations of a system according to a first example variation.

FIG. 12 is a diagram showing an example of operations of a system according to a second example variation.

FIG. 13 is a diagram showing an example of a computer that realizes the structure optimization apparatus.

### EXAMPLE EMBODIMENT

### Example Embodiment

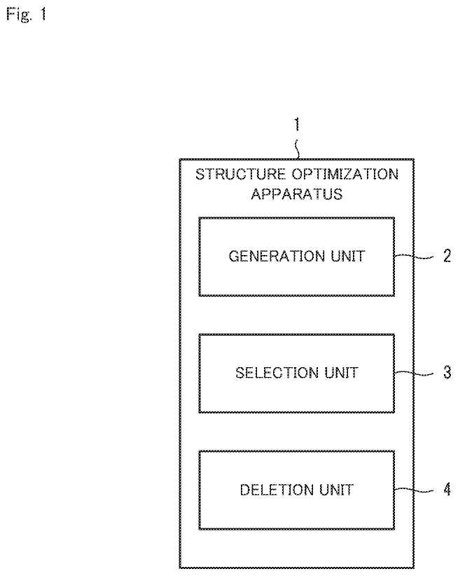

Hereinafter, an example embodiment of the invention will be described with reference to FIGS. 1 to 13.

[Apparatus Configuration]

First, a configuration of a structure optimization apparatus 1 according to the example embodiment will be described with reference to FIG. 1. FIG. 1 is a diagram showing an example of a structure optimization apparatus.

The structure optimization apparatus 1 shown in FIG. 1 is an apparatus for optimizing a structured network to reduce the calculation amount of a computing unit. Examples of the structure optimization apparatus 1 include a CPU, a GPU, or a programmable device such as an FPGA, or an information processing device including a computing unit including one or more of the above. Also, as shown in FIG. 1, the structure optimization apparatus 1 includes a generation unit 2, a selection unit 3, and a deletion unit 4.

Of these, the generation unit 2 generates a residual network that shortcuts one or more intermediate layers in the structured network. The selection unit 3 selects intermediate layers according to the degree of contribution (first degree of contribution) of the intermediate layers to processing executed using the structured network. The deletion unit 4 deletes the selected intermediate layers.

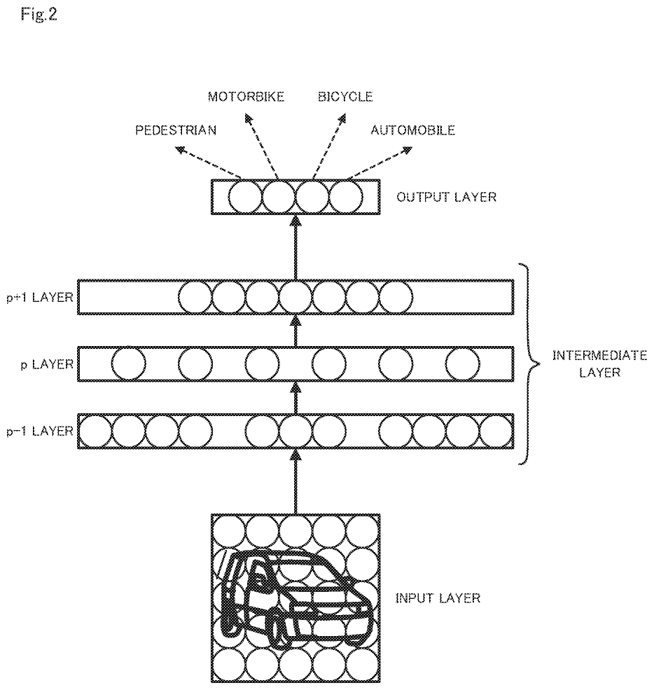

The structured network is a learning model that is generated through machine learning and includes an input layer, an output layer and intermediate layers that each include neurons. FIG. 2 is a diagram showing an example of a learning model. An example shown in FIG. 2 is a model in which an automobile, a bicycle, a motorbike, and a pedestrian that are captured in input images are identified and classified using the input images.

Also, in the structured network in FIG. 2, each of the neurons in the target layer are connected to some or all of the neurons in the layer above the target layer by weighted connections (connection lines).

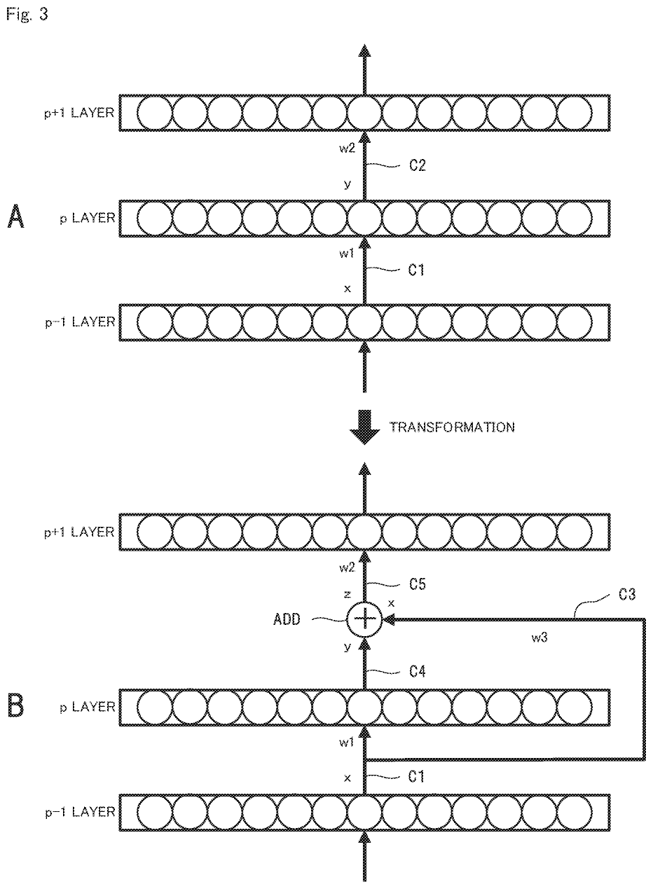

A residual network that shortcuts the intermediate layers will be described. FIG. 3 is a diagram for illustrating a residual network that shortcuts intermediate layers.

When the structured network shown in A of FIG. 3 is transformed into the structured network shown in B of FIG. 3, that is, when a residual network that shortcuts a p layer is generated, the p layer is shortcut using the connections C3, C4, C5, and an adder ADD.

In FIG. 3, a p−1 layer, the p layer, and a p+1 layer are the intermediate layers. The p−1 layer, the p layer, and the p+1 layer each have n neurons. Note that the number of neurons in the layers may also be different from each other.

The p−1 layer outputs x (x1, x2, . . . , xn) as the output values, and the p layer outputs y (y1, y2, . . . , yn) as the output values.

A connection C1 includes a plurality of connections that connect each of the outputs of the neurons in the p−1 layer to all the inputs of the neurons in the p layer. The plurality of connections included in the connection C1 are each weighted.

Also, in the example shown in FIG. 3, since there are n×n connections included in the connection C1, there are n×n weights as well. In the following description, the n×n weights of the connection C1 may be referred to as w1.

A connection C2 includes a plurality of connections that connect each of the outputs of the neurons in the p layer to all the inputs of the neurons in the p+1 layer. The plurality of connections included in the connection C2 are each weighted.

Also, in the example shown in FIG. 3, since there are n×n connections included in the connection C2, there are n×n weights as well. In the following description, the n×n weights of the connection C2 may be referred to as w2.

A connection C3 includes a plurality of connections that connect each of the outputs of the neurons in the p−1 layer to all the inputs of the adder ADD. The plurality of connections included in the connection C3 are each weighted.

Also, in the example shown in FIG. 3, since there are n×n connections included in the connection C3, there are n×n weights as well. In the following description, the n×n weights of the connection C3 may be referred to as w3. Here, the weight w3 may be a value obtained by identically transforming the output value x in the p−1 layer, or a value obtained by multiplying the output value x by a constant.

A connection C4 includes a plurality of connections that connect each of the outputs of neurons in the p layer to all the inputs of the adder ADD. Each of the plurality of connections included in the connection C4 is weighted to perform an identical transformation on the output value y in the p layer.

The adder ADD adds the values determined by the output values x in the p−1 layer obtained from the connection C3 and values determined by the weights w3 (n elements) and the output values y in the p layer obtained from the connection C4 (n elements) to calculate the output values z (z1, z2, . . . , zn).

A connection C5 includes a plurality of connections that connect each of the outputs of the adder ADD to all the inputs of the neurons in the p+1 layer. The plurality of connections included in the connection C5 are each weighted. Note that the above-described n is an integer that is 1 or greater.

Also, although shortcutting of one intermediate layer is shown in FIG. 3 to simplify description, a plurality of residual networks that shortcut the intermediate layers may be provided in the structured network.

The degree of contribution of an intermediate layer is determined using the weights of the connections used for connecting the neurons in the target intermediate layer to the intermediate layer provided in the layer below the target intermediate layer. In B in FIG. 3, in the case of calculating the degree of contribution of the p layer, the degree of contribution of the intermediate layer is calculated using the weight w1 of the connection C1. For example, the weights of the plurality of connections included in the connection C1 are totaled to calculate a total value, and the calculated total value is taken as the degree of contribution.

Regarding the selection of the intermediate layers, for example, it is determined whether or not the degree of contribution is a predetermined threshold value (first threshold value) or more, and the intermediate layers to be deleted are selected according to the determination result.

In this manner, in the example embodiment, the intermediate layers whose degree of contribution to processing executed using the structured network is low are deleted after the residual network that shortcuts the intermediate layers is generated in the structured network, and thus the structured network can be optimized. Accordingly, the calculation amount of the computer can be reduced.

Also, in the example embodiment, by optimizing the structured network by providing the residual network therein, a decrease in the accuracy of processing such as identification and classification can be suppressed. Generally, in a structured network, a decrease in the number of intermediate layers and neurons leads to a decrease in the accuracy of processing such as identification and classification, but the intermediate layers whose degree of contribution is high are not deleted, and thus a decrease in the accuracy of processing such as identification and classification can be suppressed.

In the example shown in FIG. 2, when an image in which an automobile is captured is input to the input layer, intermediate layers that are important in identifying and classifying the subject captured in the image in the output layer as being an automobile are not deleted because the degree of contribution to processing is considered to be high.

Further, in the example embodiment, the program size can be reduced by optimizing the structured network as described above, and thus the scale of the computing unit, memory, and the like can be reduced. As a result, the apparatus can be miniaturized.

[System Configuration]

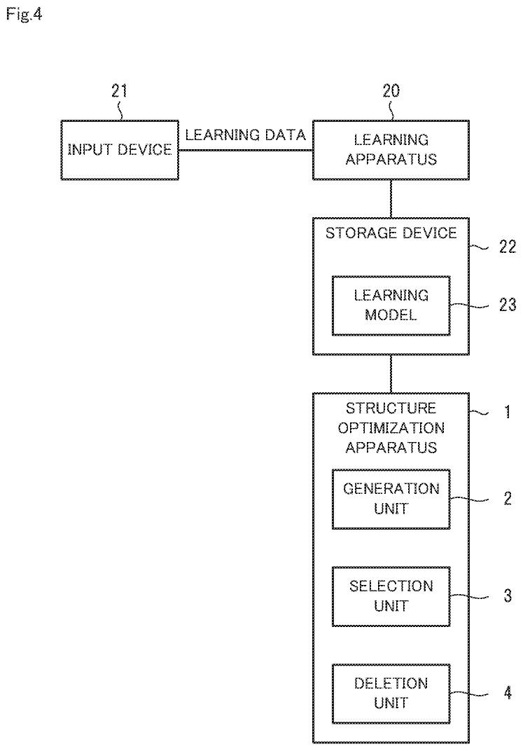

Next, the configuration of the structure optimization apparatus 1 according to the example embodiment will be illustrated in more detail using FIG. 4. FIG. 4 is a diagram showing an example of a system having a structure optimization apparatus.

As shown in FIG. 4, a system in the example embodiment includes a learning apparatus 20, an input device 21, and a storage device 22 in addition to the structure optimization apparatus 1. The storage device 22 stores a learning model 23.

The learning apparatus 20 generates the learning model 23 based on learning data. Specifically, first, the learning apparatus 20 obtains a plurality of pieces of learning data from the input device 21. Next, the learning apparatus 20 generates the learning model 23 (structured network) using the obtained learning data. Next, the learning apparatus 20 stores the generated learning model 23 in the storage device 22. Note that the learning apparatus 20 may be an information processing apparatus such as a server computer.

The input device 21 is a device that inputs, to the learning apparatus 20, learning data that is used to cause the learning apparatus 20 to learn. Note that, the input device 21 may be an information processing apparatus such as a personal computer, for example.

The storage device 22 stores the learning model 23 generated by the learning apparatus 20. Also, the storage device 22 stores the learning model 23 in which the structured network is optimized using the structure optimization apparatus 1. Note that, the storage device 22 may also be provided inside the learning apparatus 20. Alternatively, the storage device 22 may be provided inside the structure optimization apparatus 1.

The structure optimization apparatus will be described.

The generation unit 2 generates a residual network that shortcuts one or more intermediate layers in the structured network included in the learning model 23. Specifically, first, the generation unit 2 selects intermediate layers for which the residual network is to be generated. The generation unit 2 selects some or all of the intermediate layers, for example.

Next, the generation unit 2 generates the residual network with respect to the selected intermediate layers. For example, as shown in B in FIG. 3, if the target intermediate layer is the p layer, the connection C3 (first connection), C4 (second connection), C5 (third connection), and an adder ADD are generated, and the residual network is generated using these connections and the adder.

The generation unit 2 connects one end of the connection C3 to the output of the p−1 layer, and the other end thereof to one input of the adder ADD. Also, the generation unit 2 connects one end of the connection C4 to the output of the p layer, and the other end thereof to the other input of the adder ADD. Also, the generation unit 2 connects one end of the connection C5 to the output of the adder ADD, and the other side thereof to the input of the p+1 layer.

Further, the connection C3 included in the residual network may be weighted with a weight for performing identical transformation of the input value x or a weight for performing constant multiplication of the input value x by a constant as the weight w3.

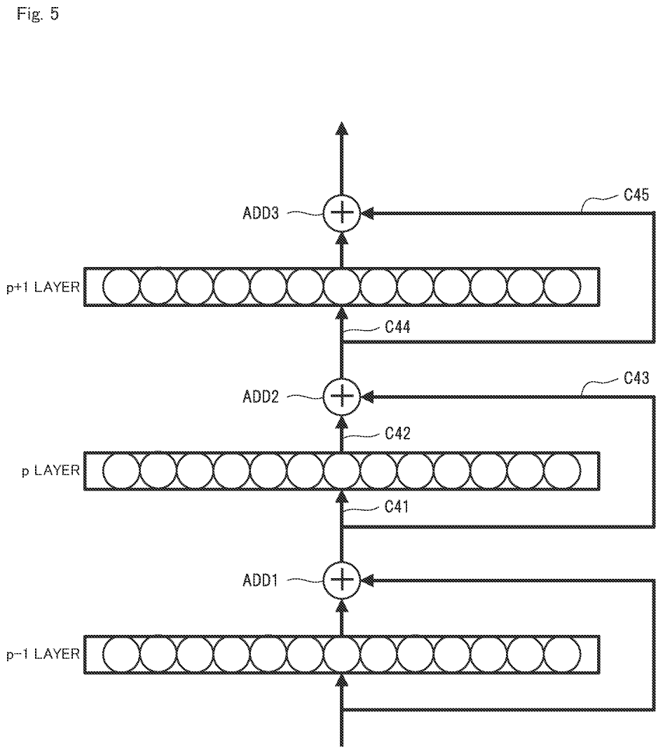

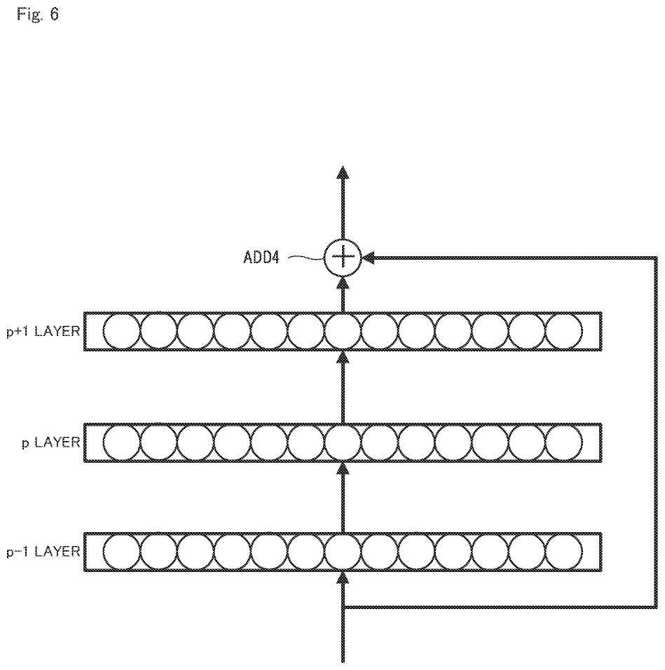

Note that, a residual network may be provided for each intermediate layer as shown in FIG. 5, or a residual network that shortcuts a plurality of intermediate layers may be provided as shown in FIG. 6. FIGS. 5 and 6 are diagrams showing examples of residual networks.

The selection unit 3 selects intermediate layers to be deleted according to the degree of contribution of the intermediate layers to processing executed using the structured network (first degree of contribution). Specifically, first, the selection unit 3 obtains the weights of the connections connected to the input of the target intermediate layer.

Next, the selection unit 3 totals the obtained weights and the total value of the weights is taken as the degree of contribution. In B in FIG. 3, in the case of calculating the degree of contribution of the p layer, the selection unit 3 calculates the degree of contribution of the intermediate layers using the weight w1 of the connection C1. For example, the selection unit 3 totals the weights of the connections included in the connection C1 and the calculated total value is taken as the degree of contribution.

Next, the selection unit 3 determines whether the degree of contribution is a predetermined threshold (first threshold) or more and selects intermediate layers according to the determination result. The threshold value may be obtained using testing, a simulator, or the like, for example.

When the degree of contribution is a predetermined threshold or more, the selection unit 3 determines that the target intermediate layer has a high degree of contribution to processing executed using the structured network. Also, when the degree of contribution is smaller than the threshold value, the selection unit 3 determines that the target intermediate layer has a low degree of contribution to processing executed using the structured network.

The deletion unit 4 deletes the intermediate layers selected using the selection unit 3. Specifically, first, the deletion unit 4 obtains information indicating the intermediate layers with a degree of contribution that is smaller than the threshold value. Next, the deletion unit 4 deletes the intermediate layers whose degree of contribution is smaller than the threshold value.

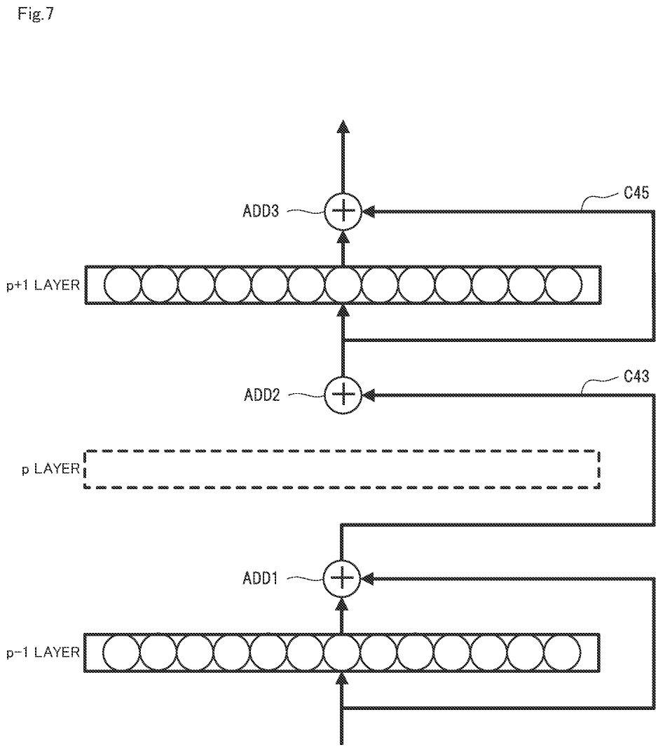

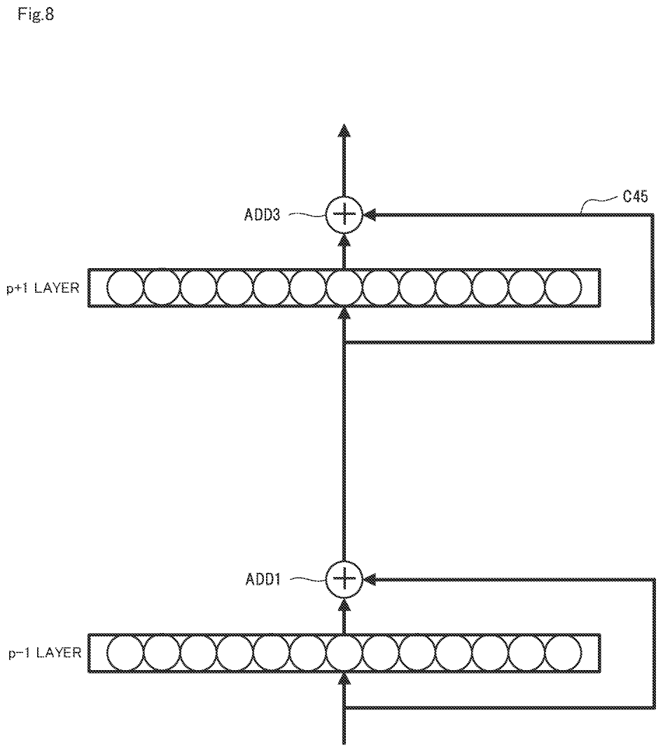

The deletion of the intermediate layers will be described using FIGS. 7 and 8. FIGS. 7 and 8 are diagrams showing an example in which intermediate layers have been deleted from the structured network.

For example, when a residual network such as shown in FIG. 5 is provided and the degree of contribution of the p layer is smaller than the threshold value, the deletion unit 4 deletes the p layer. As a result, the configuration of the structured network shown in FIG. 5 will be as shown in FIG. 7.

In other words, since there is no input from the connection C42 to the adder ADD2, each of the outputs of the adder ADD1 is connected to all the inputs of the p+1 layer as shown in FIG. 8.

### First Example Variation

A first example variation will be described. Even if the degree of contribution (first degree of contribution) of the selected intermediate layer to processing is low, neurons whose degree of contribution to processing (second degree of contribution) is high may be included in the neurons in the selected intermediate layer, and deletion of such neurons may decrease the accuracy of processing.

In view of this, in the first example variation, when the selected intermediate layer includes neurons whose degree of contribution is high, in order to not delete that intermediate layer, the above selection unit 3 is provided with an additional function.

Specifically, the selection unit 3 selects intermediate layers selected as deletion targets according to the degree of contribution of neurons included in the intermediate layers to processing (second degree of contribution).

In this manner, in the first example variation, when a neuron whose degree of contribution is high is included in an intermediate layer selected as a deletion target, the selected intermediate layer is excluded from the deletion targets, and thus a decrease in the processing accuracy can be suppressed.

The first example variation will be specifically described.

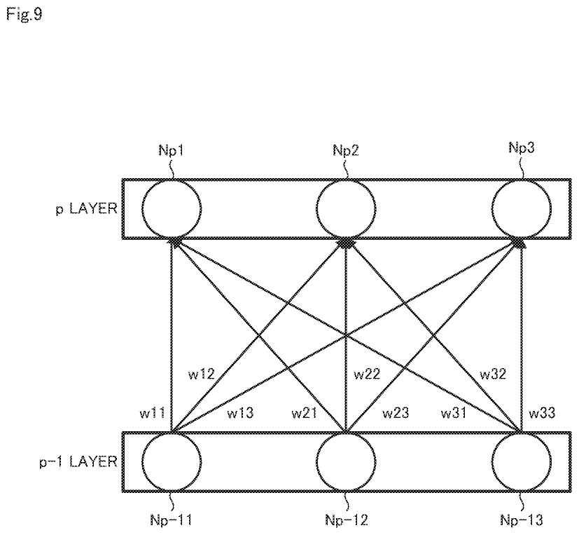

FIG. 9 is a diagram showing an example of the connection between neurons and connections. The selection unit 3 obtains the weights of the connections connected to each neuron in the p layer, which is the target intermediate layer. Next, the selection unit 3 totals the weights obtained for each neuron in the p layer, and the total value is taken as the degree of contribution.

The degree of contribution of a neuron Np1 in the p layer in FIG. 9 is obtained by calculating the total value of w11, w21, and w31. Further, the degree of contribution of a neuron Np2 in the p layer is obtained by calculating the total value of w12, w22, and w32. Further, the degree of contribution of a neuron Np3 in the p layer is obtained by calculating the total value of w13, w23, and w33.

Next, the selection unit 3 determines whether the degree of contribution for each of the neurons in the p layer is a predetermined threshold (second threshold) or more. The threshold value may be obtained using testing, a simulator, or the like, for example.

Next, if the degree of contribution of a neuron is a predetermined threshold or more, the selection unit 3 determines that the degree of contribution of this neuron to processing executed using the structured network is high and excludes the p layer from the deletion targets.

On the other hand, if the degrees of contribution of all the neurons in the p layer are smaller than the threshold value, the selection unit 3 determines that the degree of contribution of the target intermediate layer to processing executed using the structured network is low, and selects the p layer as a deletion target. Next, the deletion unit 4 deletes the intermediate layers selected by the selection unit 3.

The following is another example of a method for calculating the degree of contribution. The degrees to which the estimation in the output layer is affected when the output values of all the neurons that belong to the p layer are varied by a minute amount is measured for each neuron, and the magnitude is taken as the degree of contribution. Specifically, data with the correct answer is input to obtain the output value by a normal method. On the other hand, when one output value of a neuron in the p layer of interest is increased or decreased by a prescribed minute amount 6, the absolute value of the change amount of the corresponding output value can be taken as the degree of contribution. The output of the p layer neurons can be changed by ±6, and the absolute value of the difference between the output values can be taken as the degree of contribution.

In this manner, in the first example variation, if a neuron whose degree of contribution is high is included in the selected intermediate layer, that intermediate layer is not deleted, and thus a decrease in the processing accuracy can be suppressed.

### Second Example Variation

The second example variation will now be described. Even if the degree of contribution of the selected intermediate layer to processing (first degree of contribution) is low, a neuron whose degree of contribution to processing (second degree of contribution) is high may be included in the neurons in the selected intermediate layer, and deletion of such a neuron may decrease the accuracy of the processing.

In view of this, in the second example variation, if a neuron whose degree of contribution is high is included in the selected intermediate layer, that intermediate layer is not deleted and only neurons whose degree of contribution is low are deleted.

In the second example variation, the selection unit 3 selects neurons included in selected intermediate layers according to the degree of contribution of the neurons to processing (second degree of contribution). The deletion unit 4 deletes the selected neurons.

In this manner, in the second example variation, when a neuron whose degree of contribution is high is included in the selected intermediate layer, the selected intermediate layer is not deleted and only the neuron whose degree of contribution is low is deleted, and thus a decrease in the processing accuracy can be suppressed.

The second example variation will now be specifically described.

The selection unit 3 obtains the weights of the connections connected to the neurons for each neuron in the p layer, which is the target intermediate layer. Next, the selection unit 3 totals the obtained weights for each of the neurons in the p layer, and the total value is taken as the degree of contribution.

Next, the selection unit 3 determines whether the degree of contribution for each neuron in the p layer is a predetermined threshold (second threshold) or more, and selects the neuron in the p layer according to the determination result.

Next, if the degree of contribution of the neuron is a predetermined threshold or more, the selection unit 3 determines that the degree of contribution of this neuron to processing executed using the structured network is high, and excludes the neuron from the deletion targets.

On the other hand, if the degree of contribution of the neuron in the p layer is smaller than the threshold value, the selection unit 3 determines that the degree of contribution of the neuron to processing executed using the structured network is low, and selects the neuron whose degree of contribution is low as a deletion target. Next, the deletion unit 4 deletes the neuron selected by the selection unit 3.

In this manner, in the second example variation, if a neuron whose degree of contribution is high is included in the selected intermediate layer, the selected intermediate layer is not deleted and only neurons whose degree of contribution is low is deleted, and thus a decrease in the processing accuracy can be suppressed.

[Apparatus Operations]

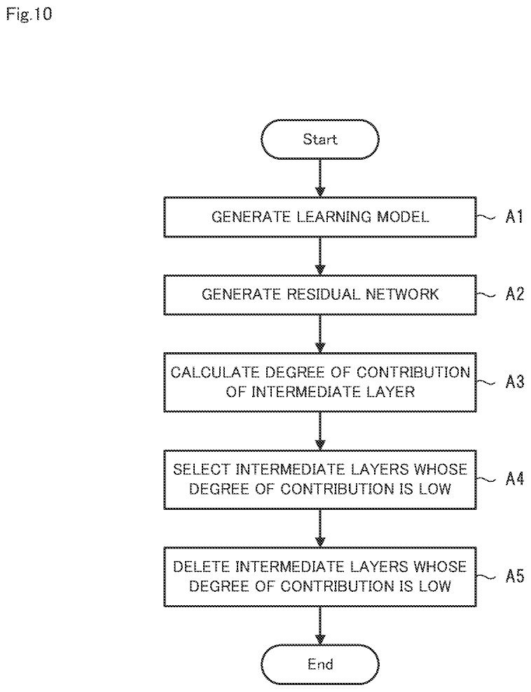

Next, the operations of the structure optimization apparatus according to the example embodiment of the invention will be described using FIG. 10. FIG. 10 is a diagram illustrating an example of the operations of a system of the structure optimization apparatus. In the description below, FIG. 1 to FIG. 9 are referenced as appropriate. Furthermore, in the example embodiment, the structure optimization method is carried out by operating the structure optimization apparatus. Therefore, the following description of the operations of the structure optimization apparatus of the example embodiment applies to the structure optimization method according to the present example embodiment.

As shown in FIG. 10, first, the learning model 23 is generated based on learning data (step A1). Specifically, in step 1, first, the learning apparatus 20 obtains a plurality of pieces of learning data from the input device 21.

Next, in step A1, the learning apparatus 20 generates the learning model 23 (structured network) using the obtained learning data. Next, in step A1, the learning apparatus 20 stores the generated learning model 23 in the storage device 22.

Next, the generation unit 2 generates a residual network that shortcuts one or more intermediate layers in the structured network included in the learning model 23 (step A2). Specifically, in step A2, first, the generation unit 2 selects the intermediate layers for which the residual network is to be generated. For example, the generation unit 2 selects some or all of the intermediate layers.

Next, in step A2, the generation unit 2 generates the residual network for the selected intermediate layers. For example, if the target intermediate layer is the p layer as shown in B of FIG. 3, the connection C3 (first connection), C4 (second connection), C5 (third connection), and an adder ADD are generated, and the residual network is generated using the generated connections and adder.

Next, the selection unit 3 calculates the degree of contribution for each intermediate layer to processing executed using the structured network (first degree of contribution) (step A3). Specifically, in step A3, first, the selection unit 3 obtains the weights of the connections connected to the inputs of the target intermediate layer.

Next, in step A3, the selection unit 3 totals the obtained weights and the total value is taken as the degree of contribution. In B in FIG. 3, when the degree of contribution of the p layer is calculated, the degree of contribution of the intermediate layer is calculated using the weight w1 of the connection C1. For example, the selection unit 3 totals the weights of the connections included in the connection C1, and the calculated total value is the degree of contribution.

Next, the selection unit 3 selects the intermediate layers to be deleted according to the calculated degree of contribution (step A4). Specifically, in step A4, the selection unit 3 determines whether the degree of contribution is a predetermined threshold (first threshold) or more, and selects the intermediate layers according to the determination result.

For example, in step A4, when the degree of contribution is a predetermined threshold value or more, the selection unit 3 determines that the degree of contribution of the target intermediate layer to processing executed using the structured network is high. Also, when the degree of contribution is smaller than the threshold value, the selection unit 3 determines that the degree of contribution of the target intermediate layer to processing executed using the structured network is low.

Next, the deletion unit 4 deletes the intermediate layers selected using the selection unit 3 (step A5). Specifically, in step A5, the deletion unit 4 obtains information indicating the intermediate layers whose degree of contribution is smaller than the threshold value. Next, in step A5, the deletion unit 4 deletes the intermediate layers whose degree of contribution is smaller than the threshold value.

### First Example Variation

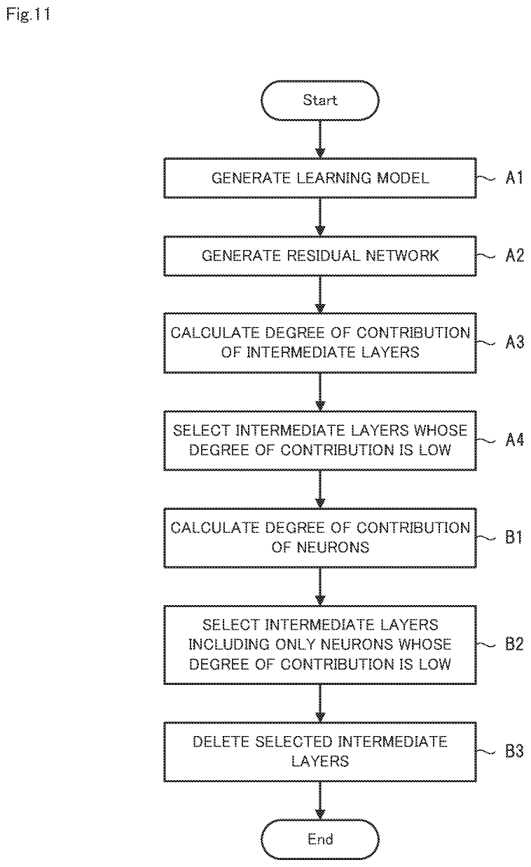

The operations of the first example variation will now be described using FIG. 11. FIG. 11 is a diagram showing an example of the operations of the system in the first example variation.

As shown in FIG. 11, first, the processing of steps A1 to A4 is performed. Since the processing of steps A1 to A4 has been already described, a description will not be given here.

Next, the selection unit 3 calculates, for each selected intermediate layer, the degree of contribution of each of the neurons included in the intermediate layer (second degree of contribution)(step B1). Specifically, in step B1, the selection unit 3 obtains the weights of the connected connections for each of the neurons in the target intermediate layer. Next, the selection unit 3 totals the weights for each neuron and the total value is taken as the degree of contribution.

Next, the selection unit 3 selects intermediate layers to be deleted according to the calculated degree of contribution for each neuron (step B2). Specifically, in step B2, the selection unit 3 determines whether the degree of contribution is a predetermined threshold (second threshold) or more for each neuron in the selected intermediate layers.

Next, in step B2, if there is a neuron whose degree of contribution is a predetermined threshold or more in the selected intermediate layer, the selection unit 3 determines that the degree of contribution of this neuron to processing executed using the structured network is high, and excludes the selected intermediate layer from the deletion targets.

On the other hand, in step B2, if the degrees of contribution of all the neurons in the selected intermediate layer are smaller than the threshold, the selection unit 3 determines that the degree of contribution of the target intermediate layer to processing executed using the structured network is low, and selects the target intermediate layer as a deletion target.

Next, the deletion unit 4 deletes the intermediate layers selected as deletion targets by the selection unit 3 (step B3).

In this manner, in the first example variation, when a neuron whose degree of contribution is high is included in a selected intermediate layer, that intermediate layer is not deleted, and thus a decrease in the processing accuracy can be suppressed.

### Second Example Variation

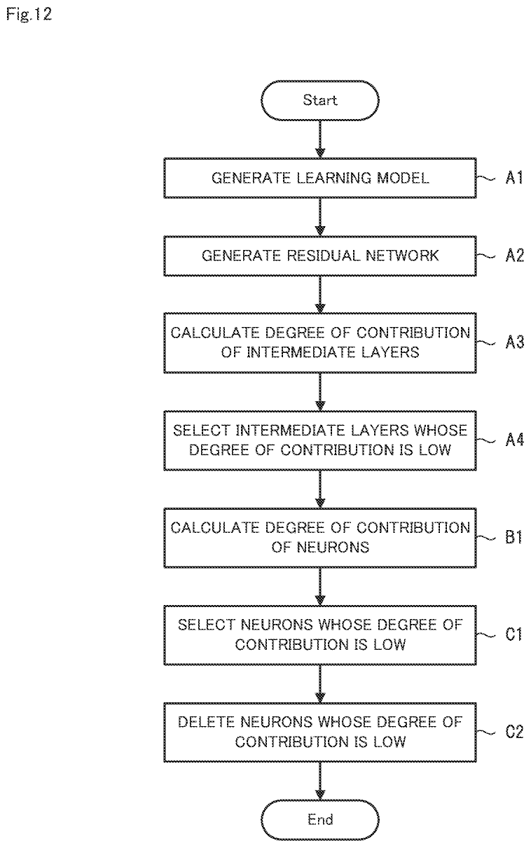

The operations of the second example variation will now be described using FIG. 12. FIG. 12 is a diagram showing an example of the operations of the system in the second example variation.

As shown in FIG. 12, first, the processing of steps A1 to A4 and step B1 is performed. The processing of steps A1 to A4 and step B1 has been already described and a description will not be given here.

Next, the selection unit 3 selects neurons to be deleted according to the calculated degree of contribution for each neuron (step C1). Specifically, in step C1, the selection unit 3 determines whether the degree of contribution is a predetermined threshold (second threshold) or more for each neuron in the selected intermediate layer.

Next, in step C1, if there is a neuron whose degree of contribution is a predetermined threshold or more, the selection unit 3 determines that the degree of contribution of this neuron to processing executed using the structured network is high, and excludes the selected intermediate layer from the deletion targets.

On the other hand, in step C1, if the degree of contribution of the selected neuron is smaller than the threshold, the selection unit 3 determines that the degree of contribution of the target neuron to processing executed using the structured network is low, and selects the target neuron as a deletion target.

Next, the deletion unit 4 deletes the neurons selected as deletion targets by the selection unit 3 (step C2).

In this manner, in the second example variation, when a neuron whose degree of contribution is high is included in a selected intermediate layer, the selected intermediate layer is not deleted and only neurons that have a low degree of contribution are deleted, and thus a decrease in the processing accuracy can be suppressed.

### Effects of Example Embodiment

As described above, according to the example embodiment, a residual network that shortcuts an intermediate layer is generated in the structured network, and after that the intermediate layers whose degree of contribution to processing executed using the structured network is low are deleted, and thus the structured network can be optimized. Accordingly, the calculation amount of the computing unit can be reduced.

Further, in the example embodiment, as described above, a residual network is provided in the structured network to optimize the structured network, and thus a decrease in the accuracy of processing such as identification and classification can be suppressed. Generally, in the structured network, a decrease in the number of intermediate layers and neurons leads to a decrease in the accuracy of processing such as identification and classification, but the intermediate layers whose degree of contribution is high are not deleted, and thus a decrease in the accuracy of processing such as identification and classification can be suppressed.

In the example shown in FIG. 2, when the image in which the automobile is captured is input to the input layer, the intermediate layers that are necessary to identify and classify the subject captured on the image in the output layer as an automobile are not deleted because such intermediate layers have a high degree of contribution to processing.

Further, in the example embodiment, if the structured network is optimized as described above, programs can be downsized, and thus the scale of a computing unit, a memory, and the like can be downsized. As a result, an apparatus can be made smaller.

[Program]

A program according to the example embodiment of the invention need only be a program that causes a computer to carry out steps A1 to A5 in FIG. 10, steps A1 to A4 and B1 to B3 in FIG. 11, steps A1 to A4, B1, C1, and C2 in FIG. 12, or two or more thereof.

The structure optimization apparatus and structure optimization method according to the example embodiment can be realized by this program being installed in the computer and executed. In this case, a processor of the computer performs processing while functioning as the generation unit 2, the selection unit 3, and the deletion unit 4.

Also, the program of the example embodiment may also be executed by the computer system constituted by a plurality of computers. In this case, for example, the computers may each function as one of the generation unit 2, the selection unit 3, and the deletion unit 4.

[Physical Configuration]

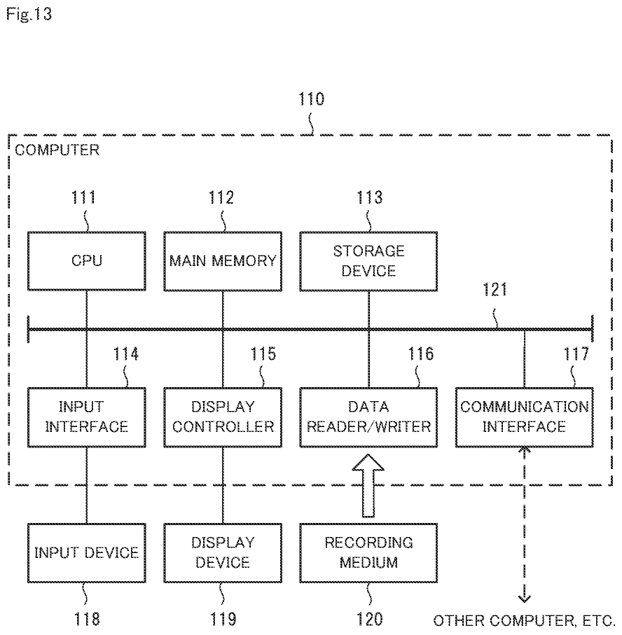

Here, a computer that realizes the structure optimization apparatus by executing a program of the example embodiment and the first and second example variations will be described, using FIG. 13. FIG. 13 is a block diagram showing an example of a computer that realizes the structure optimization apparatus according to the example embodiment of the invention.

As shown in FIG. 13, a computer 110 includes a CPU (Central Processing Unit) 111, a main memory 112, a storage device 113, an input interface 114, a display controller 115, a data reader/writer 116, and a communication interface 117. These units are connected to each other via a bus 121 so as to be able to communicate data. Note that the computer 110 may include a GPU (Graphics Processing Unit) or an FPGA (Field-Programmable Gate Array), in addition to the CPU 111 or instead of the CPU 111.

The CPU 111 loads the program (codes) according to the present example embodiment that is stored in the storage device 113 to the main memory 112 and executes the program in a predetermined order, thereby performing various kinds of computation. The main memory 112 is typically a volatile storage device such as a DRAM (Dynamic Random Access Memory). The program according to the example embodiment is provided in a state of being stored in a computer-readable recording medium 120. Note that the program according to the example embodiment may also be distributed on the Internet to which the computer is connected via the communication interface 117.

Specific examples of the storage device 113 may include a hard disk drive, a semiconductor storage device such as a flash memory, and the like. The input interface 114 mediates data transmission between the CPU 111 and input devices 118 such as a keyboard and a mouse. The display controller 115 is connected to a display device 119 and controls a display in the display device 119.

The data reader/writer 116 mediates data transmission between the CPU 111 and the recording medium 120, reads out the program from the recording medium 120, and writes, in the recording medium 120, the results of processing performed by the computer 110. The communication interface 117 mediates data transmission between the CPU 111 and other computers.

Specific examples of the recording medium 120 may include a general-purpose semiconductor storage device such as a CF (Compact Flash (registered trademark)) or an SD (Secure Digital), a magnetic recording medium such as a Flexible Disk, and an optical recording medium such as a CD-ROM (Compact Disk Read Only Memory).

[Supplementary Note]

In relation to the above example embodiment, the following Supplementary Notes are further disclosed. The example embodiments described above can be partially or wholly realized by supplementary notes 1 to 12 described below, although the invention is not limited to the following description.

(Supplementary Note 1)

A structure optimization apparatus including:

a generation unit configured to generate a residual network that shortcuts one or more intermediate layers in a structured network;

a selection unit configured to select an intermediate layer according to a first degree of contribution of the intermediate layer to processing executed using the structured network; and

a deletion unit configured to delete the selected intermediate layer.

(Supplementary Note 2)

The structure optimization apparatus according to supplementary note 1,

wherein the selection unit further selects the selected intermediate layer according to a second degree of contribution of a neuron included in the intermediate layer to the processing.

(Supplementary Note 3)

The structure optimization apparatus according to supplementary note 1 or 2,

wherein the selection unit further selects a neuron included in the selected intermediate layer according to the second degree of contribution of the neuron to the processing, and

the deletion unit further deletes the selected neuron.

(Supplementary Note 4)

The structure optimization apparatus according to any one of supplementary notes 1 to 3,

wherein a connection included in the residual network includes a weight for performing constant multiplication of an input value for multiplying an input value by a constant.

(Supplementary Note 5)

A structure optimization method including:

a generating step for generating a residual network that shortcuts one or more intermediate layer in a structured network;

a selecting step for selecting an intermediate layer according to a first degree of contribution of the intermediate layer to processing executed using the structured network; and

a deleting step for deleting the selected intermediate layer.

(Supplementary Note 6)

The structure optimization method according to supplementary note 5,

wherein, in the selecting step, the selected intermediate layer is selected according to a second degree of contribution of a neuron included in the intermediate layer to the processing.

(Supplementary Note 7)

The structure optimization method according to supplementary note 5 or 6,

wherein, in the selecting step, a neuron included in the selected intermediate layer is further selected according to a second degree of contribution of the neuron to the processing, and in the deleting step, the selected neuron is further deleted.

(Supplementary Note 8)

The structure optimization method according to any one of supplementary notes 5 to 7,

wherein a connection included in the residual network includes a weight for performing constant multiplication of an input value.

(Supplementary Note 9)

A computer-readable recording medium that includes a program recorded thereon, the program including instructions that cause a computer to carry out:

a generating step for generating a residual network that shortcuts one or more intermediate layer in a structured network;

a selecting step for selecting an intermediate layer according to a first degree of contribution of the intermediate layer to processing executed using the structured network; and

a deleting step for deleting the selected intermediate layer.

(Supplementary Note 10)

The computer-readable recording medium according to supplementary note 9,

wherein, in the selecting step, the intermediate layer is selected according to a second degree of contribution of a neuron included in the selected intermediate layer to the processing.

(Supplementary Note 11)

The computer-readable recording medium according to supplementary note 9 or 10,

wherein, in the selecting step, the neuron is further selected according to a second degree of contribution of a neuron included in the selected intermediate layer to the processing, and

in the deleting step, the selected neuron is further deleted.

(Supplementary Note 12)

The computer-readable recording medium according to any one of supplementary notes 9 to 11,

wherein a connection included in the residual network includes a weight that multiplies an input value by a constant.

The invention of the present application has been described above with reference to the present example embodiment, but the invention of the present application is not limited to the above example embodiment. The configurations and the details of the invention of the present application may be changed in various manners that can be understood by a person skilled in the art within the scope of the invention of the present application.

This application is based upon and claims the benefit of priority from Japanese application No. 2019-218605, filed on Dec. 3, 2019, the disclosure of which is incorporated herein in its entirety by reference.

### INDUSTRIAL APPLICABILITY

As described above, according to the invention, a structured network can be optimized and the calculation amount of a computing unit can be reduced. The invention is useful in fields in which optimization of a structured network is required.

### LIST OF REFERENCE SIGNS

1 Structure optimization apparatus
2 Generation unit
3 Selection unit
4 Deletion unit
20 Learning apparatus
21 Input device
22 Storage device
23 Learning model
110 Computer
111 CPU
112 Main memory
113 Storage device
114 Input interface
115 Display controller
116 Data reader/writer
117 Communication interface
118 Input device
119 Display device
120 Storage medium
121 Bus

What is claimed is:

1. A structure optimization apparatus comprising:
a generation unit that generates residual network that shortcuts one or more intermediate layers in a structured network;
a selection unit that selects an intermediate layer according to a first degree of contribution of the intermediate layer to processing executed using the structured network; and
a deletion unit that deletes the selected intermediate layer.

2. The structure optimization apparatus according to claim 1,
wherein the selection unit further selects the selected intermediate layer according to a second degree of contribution of a neuron included in the intermediate layer to the processing.

3. The structure optimization apparatus according to claim 1,
wherein the selection unit further selects a neuron included in the selected intermediate layer according to the second degree of contribution of the neuron to the processing, and
the deletion unit further deletes the selected neuron.

4. The structure optimization apparatus according to claim 1,
wherein a connection included in the residual network includes a weight for performing constant multiplication of an input value for multiplying an input value by a constant.

5. A structure optimization method comprising:
generating a residual network that shortcuts one or more intermediate layer in a structured network;
selecting an intermediate layer according to a first degree of contribution of the intermediate layer to processing executed using the structured network; and
deleting the selected intermediate layer.

6. The structure optimization method according to claim 5,
wherein, in the selecting, the selected intermediate layer is selected according to a second degree of contribution of a neuron included in the intermediate layer to the processing.

7. The structure optimization method according to claim 5,
wherein, in the selecting, a neuron included in the selected intermediate layer is further selected according to a second degree of contribution of the neuron to the processing, and
in the deleting, the selected neuron is further deleted.

8. The structure optimization method according to claim 5,
wherein a connection included in the residual network includes a weight for performing constant multiplication of an input value.

9. A non-transitory computer-readable recording medium that includes a program recorded thereon, the program including instructions that cause a computer to carry out:
generating a residual network that shortcuts one or more intermediate layer in a structured network;
selecting an intermediate layer according to a first degree of contribution of the intermediate layer to processing executed using the structured network; and
deleting the selected intermediate layer.

10. The non-transitory computer-readable recording medium according to claim 9,
wherein, in the selecting, the intermediate layer is selected according to a second degree of contribution of a neuron included in the selected intermediate layer to the processing.

11. The non-transitory computer-readable recording medium according to claim 9,
wherein, in the selecting, the neuron is further selected according to a second degree of contribution of a neuron included in the selected intermediate layer to the processing, and
in the deleting, the selected neuron is further deleted.

12. The non-transitory computer-readable recording medium according to claim 9,
wherein a connection included in the residual network includes a weight that multiplies an input value by a constant.
